(19) United States
(12) Patent Application Publication
(10) Pub. No.: US 2007/0097013 A1
(43) Pub. Date: May 3, 2007

(54) ANTENNA ROTATIONAL STRUCTURE

(75) Inventor: Chi-Wen Chen, Sijhih City (TW)

Correspondence Address: NIKOLAI & MERSEREAU, P.A., 900 SECOND AVENUE SOUTH, SUITE 820, MINNEAPOLIS, MN, 55402, US

(73) Assignee: CAMEO COMMUNICATIONS, INC., Sijhih City (TW)

(21) Appl. No.: 11/163,784

(22) Filed: Oct. 31, 2005

(51) Int. Cl. H01Q 1/50; H01Q 1/24

(52) U.S. Cl. 343/906; 343/702

(57) ABSTRACT

An antenna rotational structure for use on wireless communication equipment includes an antenna, a pivotal dock and a rotational dock to form a multi-dimensional rotation structure. The alignment direction of the antenna can be adjusted according to the installed location of the wireless communication equipment to attain the optimal transmission direction of the wireless communication equipment.

### FIELD OF THE INVENTION

The present invention relates to an antenna rotational structure and particularly to a rotational structure for transmission devices outside wireless communication equipment to provide multi-dimensional rotations mating the specific directional radiation field type generated by the antenna to attain an optimal transmission direction from the wireless communication equipment.

### BACKGROUND OF THE INVENTION

Wireless communication equipment originated from the military equipment used by U.S.A. during world war II about fifty years ago. Nowadays wireless communication equipment are well developed. They are widely used in schools, medical institutions, manufacturers, warehousing industry and the like to improve communication. Development of antenna is most notable. At present the antenna can be generally divided in micro-band antenna built-in the wireless communication equipment and external antenna located outside the wireless communication equipment. The micro-band antenna can reduce the size of the wireless communication equipment and prevent the risk associated with exposure of the antenna. On the other hand, the external antenna can be adjusted to the optimal transmission direction to get optimal receiving according to the installed location of the wireless communication equipment. Hence the high performance wireless communication equipment mostly adopt the external antenna.

These days population density increases greatly. It becomes increasingly difficult to find installation sites for the wireless communication equipment with unobstructed space to transmit signals. As a result, antenna transmission and receiving also become more difficult. Hence transmission angle and direction of the antenna have to be adjusted according to the installed location of the wireless communication equipment. The external antenna generally can provide rotation and anchoring function. It is especially useful in the narrow and dense space. A conventional external antenna as shown in FIG. 3 includes an external connection dock 40 which has trough 41 and a first aperture 42 formed respectively on two sides of the trough. The trough 41 has inner walls with an anchor ridge 43 abutting the first aperture 42. There is an internal connection dock 45 which has a coupling head 46 with anchor flutes 47 corresponding to and engageable with the anchor ridge 43. The external connection dock 40 may be coupled with the internal connection dock 45 by inserting a rivet 44 through the first aperture 42 into a second aperture 48 formed on the coupling head 46. Thus the external connection dock 40 can be rotated relative to the internal connection dock 45 about the axis formed by the rivet 44, first and second apertures 42 and 48, and anchored on a selected angle. Therefore an antenna 49 can be positioned substantially vertical to the internal connection dock 45 in a first condition (as shown in FIG. 4A), or rotated to the axial direction to be aligned with the internal connection dock 45 in a second condition (as shown in FIG. 4B). Such a structure allows the antenna to be rotated and anchored so that the antenna 49 coupled on the external connection dock 40 can be positioned on a suitable wireless transmission angle and direction.

However, the antenna 49 can provide only a non-directional transmission. It alters the wireless transmission angle merely through the relative rotational angle of the external connection dock 40 and the internal connection dock 45. In the densely populated city, the congested space hinders transmission of the wireless communication equipment. By rotating the external connection dock 40 against the internal connection dock 45 to alter the relative angle between them to attain the optimal transmission angle and direction cannot meet the transmission requirement in the dense space. To obtain the required wireless transmission, users usually have to rely a more powerful wireless communication transmission power. This causes energy waste in the non-transmission directions. The wireless communication transmission of the greater power also is harmful to human body.

As the conventional technique of the external antenna that adopts relative rotation of the external connection dock and the internal connection dock to form an angle between them cannot provide desired wireless communication transmission capability in the narrow and dense space, and causes harmful effect to human body, how to provide an improved external antenna to overcome the aforesaid disadvantages is an issue remained to be resolved.

### SUMMARY OF THE INVENTION

Therefore the primary object of the invention is to provide an antenna rotational structure that has a seat turnable to mate a positional electric field generated by a communication circuit to attain an optimal transmission direction from a wireless communication equipment.

The antenna rotational structure according to the invention includes an antenna and a seat. The antenna includes a communication circuit and a cylindrical cavity. The communication circuit can generate a radiation field of a selected direction. The seat has a cylindrical boss mating the cylindrical cavity so that the antenna can be rotated relative to the seat. The cylindrical cavity is coupled with the cylindrical boss through a first rotational axis so that the antenna can be rotated about the first rotational axis relative to the seat to alter the radiation field direction.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of an embodiment of the invention;

FIG. 2 is a perspective view of an embodiment of the invention;

FIG. 3 is an exploded view of a conventional technique;

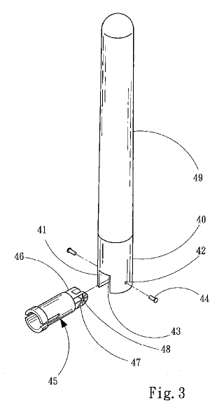

FIG. 4A is a schematic view of a conventional technique in a use condition; and

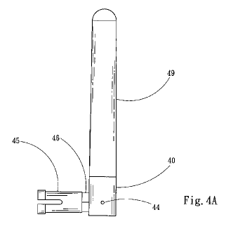

FIG. 4B is a schematic view of a conventional technique in another use condition.

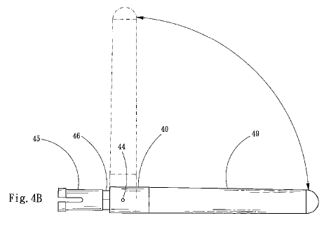

### DESCRIPTION OF THE PREFERRED EMBODIMENTS

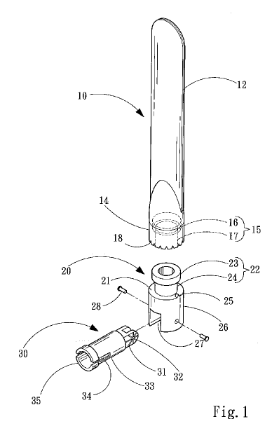

Referring to FIG. 1 for an embodiment of the invention. The antenna rotational structure of the invention includes:

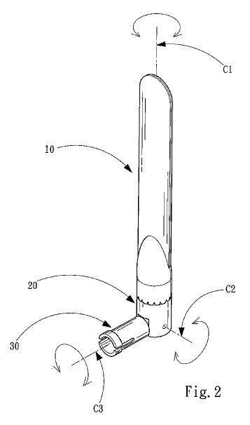

an antenna 10 which has a plate type plane 12 and a barrel 14. The plate type plane 12 consists of two symmetrical flat plates coupled together. It contains a communication circuit (not shown in the drawings) fixedly located in the antenna 10. The barrel 14 has a cylindrical cavity 15 which has a bottom 16 and a first neck 17. The bottom 16 has a diameter greater than that of the first neck 17. The barrel 14 has a bottom end formed with a plurality of anchor notches 18 that are spaced from one another at a selected distance. The cavity 15 aims to define a first rotational axis C1 (also referring to FIG. 2, will be discussed later); and

a seat which includes a pivotal dock 20 and a rotational dock 30. The pivotal dock 20 has a upper end 21 to couple with a cylindrical boss 22. The cylindrical boss 22 has a head 23 and a second neck 24. The head 23 has a diameter greater than that of the second neck 24. The head 23 can be housed in the bottom 16, and the second neck 24 can be held in the first neck 17. Thereby the cylindrical boss 22 mates the cylindrical cavity 15 to allow the antenna 10 to be rotated relative to the seat about the first axis C1. The upper end 21 has two anchor lugs 25 mating the anchor notches 18 of the barrel 14 to confine the rotational direction of the antenna 10 and anchor the antenna. The cylindrical boss 22 further has a trough 27 on a lower end 26 that is run through by two rivets 28. The rotational dock 30 has a front end 31 to be held in the trough 27. The front end 31 has two apertures 32 to engage with the two rivets 28 so that the pivotal dock 20 is pivotally coupled with the rotational dock 30. Thereby the pivotal dock 20 and the rotational dock 30 can be turned relative to each other about the two apertures 32 and the two rivets 28. The rotational dock 30 has a rear end 33 which has two opposing slots 34 and an annular ring 35.

Referring to FIG. 2, when in use, the cylindrical boss 22 is housed in the cylindrical cavity 15. The antenna 10 can be rotated relative to the pivotal dock 20 through the coupling of the cylindrical boss 22 and the cylindrical cavity 15. And the antenna 10 can be rotated and anchored on an optimal transmission direction and effect through the anchor notches 18 and the two anchor lugs 15. Through the pivotal structure of the two rivets 28 of the pivotal dock 20 and the two apertures 32 of the rotational dock 30, the pivotal dock 20 and the rotational dock 30 form a second rotational axis C2. The rear end of the rotational dock 30 can be anchored on a chassis of an electronic device (not shown in the drawings) through the annular ring 35. Thereby the rotational dock 30 and the chassis of the electronic device form a third rotational axis C3. Moreover, the communication circuit in the antenna 10 is electrically connected to the internal circuit of the electronic device through the pivotal dock 20 and the rotational dock 30.

Thus through coupling of the cylindrical boss 22 and the cylindrical cavity 15, the antenna 10 and the pivotal dock 20 can rotate relative to each other about the first rotational axis C1. Through coupling of the two rivets 28 and the two apertures 32, the pivotal dock 20 and the rotational dock 30 can rotate relative to each other about the second rotational axis C2. Finally, by coupling of the annular ring 35 with the chassis of the electronic device, the rotational dock 30 can rotate relative to the chassis of the electronic device about the third rotational axis C3.

It is to be noted that the coupling structure of the pivotal dock 20 and the rotational dock 30 that forms the seat is not the limitation of the invention. The seat may also be formed in an integrated L-shaped hollow tube with two ends coupling with the antenna 10 and the chassis of the electronic device. Thereby one end of the seat and the antenna 10 form the first rotational axis C1, and another end of the seat and the chassis form the third rotational axis C3. As a result, a two-dimensional rotational anchor structure may be formed to enable the antenna 10 to be rotated and anchored to attain the optimal transmission direction.

In addition, in the embodiment previously discussed, the anchor notches 18 are formed on the bottom end of the barrel 14, and the two anchor lugs 25 are located on the upper end of the pivotal dock 20. In practice, the positions of the anchor notches 18 and the two anchor lugs 25 may be switched. Moreover, the anchor notches 18 and the two anchor lugs 25 may also be located on the bottom side of the bottom 16 and the top side of the head 23, or on a side wall of the bottom 16 and one side of the head 23.

In summary, the antenna rotational structure of the invention provides multi-dimensional rotation and anchoring functions through the relative rotation among the antenna, pivotal dock, rotational dock and chassis. It eliminates the problem of the conventional external antenna that forms a relative rotation between the external connection dock and internal connection dock and results in difficult anchoring of the antenna. The trouble of the conventional external antenna used in a narrow and dense space that has to move the wireless communication equipment a number of times due to anchoring difficulty of the antenna also can be overcome. The invention provides a multi-dimensional rotation and anchoring structure, and can be easily adjusted to the optimal transmission direction. There is no need to increase the wireless transmission power. Harmful impact to human body can be reduced. Hence operation of the invention is more convenient, and safety can be enhanced. The advantage of wireless communication to transmit data can be fully realized.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An antenna rotational structure, comprising:
an antenna having a first coupling portion; and
a seat having a second coupling portion;
wherein the antenna and the seat are anchored by coupling of the first coupling portion and the second coupling portion such that the antenna is turnable on the seat to adjust angle.

2. The antenna rotational structure of claim 1, wherein the antenna has a barrel on one end corresponding to the seat, the first coupling portion is located in the barrel.

3. The antenna rotational structure of claim 1, wherein the first coupling portion and the second coupling portion have respectively a cylindrical boss and a cylindrical cavity mating each other.

4. The antenna rotational structure of claim 3, wherein the cylindrical cavity has a bottom and a first neck, the cylindrical boss having a head and a second neck, the head being housed in the bottom, the second neck being held in the first neck.

5. The antenna rotational structure of claim 1, wherein the antenna and the seat have respectively anchor lugs and a plurality of anchor notches formed on the juncture thereof that are corresponding to and engageable with each other to allow the antenna to be rotated and anchored.

6. The antenna rotational structure of claim 4, wherein the cylindrical cavity and the cylindrical boss have respectively anchor lugs and a plurality of anchor notches formed on the juncture thereof that are corresponding to and engageable with each other.

7. The antenna rotational structure of claim 5, wherein the anchor lugs and the anchor notches are formed respectively on a upper end of the seat and a lower end of the antenna.

8. The antenna rotational structure of claim 1, wherein the seat includes a pivotal dock and a rotational dock that are pivotally coupled with each other and turnable relative to each other.
